(19) United States
(12) Patent Application Publication
(10) Pub. No.: US 2018/0329121 A1
(43) Pub. Date: Nov. 15, 2018

(54) ANTI-GLARE PLATE MANUFACTURING METHOD AND DISPLAY DEVICE

(71) Applicant: WUHAN CHINA STAR OPTOELECTRONICS TECHNOLOGY CO., LTD., Wuhan, Hubei (CN)

(72) Inventor: Yong YANG, Shenzhen, Guangdong (CN)

(73) Assignee: Wuhan China Star Optoelectronics Technology Co., Ltd., Wuhan, Hubei (CN)

(21) Appl. No.: 15/543,988

(22) PCT Filed: Jun. 16, 2017
(86) PCT No.: PCT/CN2017/088631

§ 371 Date: Jul. 15, 2017

(30) Foreign Application Priority Data
May 9, 2017 (CN) 201710322579.7

(51) Int. Cl. G02B 5/02; G02B 27/00; C23F 1/02; C23F 1/16

(52) U.S. Cl. CPC G02B 5/0221; G02B 5/0268; C23F 1/16; G02B 27/0018; C23F 1/02; G02B 5/0294

(57) ABSTRACT

The present disclosure discloses a method for manufacturing an anti-glare plate and a display device, including: washing the plate; pre-etching the plate with a first etchant to form a rugged microstructure; and a second layer of etchant is used to etch the metal film layer and the pre-etched plate to prepare a plate having a plurality of phase-separated curved microstructures. In the above-described manner, the present disclosure can improve the sparkle phenomenon of the plate on the high-resolution panel and enhance the comfort of the panel reading.

### FIELD OF THE DISCLOSURE

The present disclosure relates to a display technology field, and more particularly to an anti-glare plate manufacturing method and a display device.

### BACKGROUND OF THE DISCLOSURE

People in the use of mobile phones are often subject to bright light and ghosting phenomenon, for this reason, people often through the mobile phone plate surface anti-glare anti-reflective treatment. At present, anti-glare treatment is one of the important ways of plate surface treatment, commonly used in the surface of the plate surface for wet etching to improve the surface roughness of the plate, increasing the plate surface diffusion. However, when the anti-glare structure of the plate surface size is too large, in the high-resolution panel will cause the sparkle phenomenon, at present, there is no way to improve the sparkle phenomenon, resulting in anti-glare plate in high-resolution panel applications are limited.

### SUMMARY OF THE DISCLOSURE

The disclosure provides an anti-glare plate manufacturing method and a display device, which can improve the sparkle phenomenon of the plate on the high resolution panel and enhance the comfort of the panel reading.

In order to solve the above technical problems, a technical aspect of the present disclosure is to provide an anti-glare plate manufacturing method, which includes: washing the plate; pre-etching the plate with a first etchant to form a rugged microstructure; depositing a layer of a mask layer with uneven thickness on the pre-etched plate; etching the mask layer and the pre-etched plate with a second etchant to produce a plate having a plurality of phase-separated curved microstructures; wherein the shape of the microstructure includes at least one of an arcuate shape, a tapered shape and a circular pan shape; the mask layer is a metal, a metal oxide and a silicate.

In order to solve the above-mentioned technical problems, another aspect of the present disclosure is to provide an anti-glare plate manufacturing method, including: washing the plate; pre-etching the plate with a first etchant to form a rugged microstructure; depositing a layer of a mask layer with uneven thickness on the pre-etched plate; etching the mask layer and the pre-etched plate with a second etchant to produce a plate having a plurality of phase-separated curved microstructures.

In order to solve the above technical problem, a further technical proposal of the disclosure is to provide a display device including an anti-glare plate and a display panel, wherein the anti-glare plate is adhered to a display surface of the display panel; wherein the method of manufacturing the anti-glare plate includes: washing the plate; pre-etching the plate with a first etchant to form a rugged microstructure; depositing a layer of the mask with uneven thickness on the plate after the pre-etching; etching the mask layer and the pre-etched plate with a second etchant to produce a plate having a plurality of phase-separated curved microstructures; the shape of the microstructure including at least one of an arcuate shape, a tapered shape and a circular table shape; the mask layer is one of metal, metal oxide and silicate; each of the phase-separated curved microstructures having a crack surface and a central angle of 50° to 80, and a groove being formed between the adjacent phase-separated curved microstructures by etching; the first etchant is a mixed acid of hydrofluoric acid, phosphoric acid and sulfuric acid, and the concentration of the first etchant is 0.5 wt % to 1 wt %, and the second etchant is a mixed acid of hydrofluoric acid, phosphoric acid and sulfuric acid, and the concentration of the second etchant is from 10 wt % to 20 wt %. The present disclosure has the advantages that, in contrast to the prior art, the present disclosure produces a plurality of phase-separated curved microstructures by multi-step etching on a plate, can improve the plate in the high-resolution panel surface sparkle phenomenon, help to enhance the comfort of panel reading.

### BRIEF DESCRIPTION OF THE DRAWINGS

FIG. 1 is a schematic flow diagram of an embodiment of the manufacturing method of the anti-glare plate of the present disclosure;

FIG. 2 is a schematic structural view of an embodiment of the manufacturing process of the anti-glare plate of the present disclosure;

FIG. 3 is a schematic illustration of the structure of the anti-glare plate of the present disclosure under specular electron microscopy;

FIG. 4 is a schematic representation of the display effect of the full HD resolution panel of the present disclosure in a bonded/non-conformable anti-glare plate;

FIG. 5 is a schematic view showing the comparison of the optical properties of the surface cracked curved microstructure plate and the surface curved microstructure plate of the present disclosure;

FIG. 6 is a schematic structural view of an embodiment of the display device of the present disclosure.

### DETAILED DESCRIPTION OF PREFERRED EMBODIMENTS

The embodiments described in the embodiments of the present disclosure will now be described in conjunction with the accompanying drawings in the embodiments of the present disclosure, and it will be apparent that the described embodiments are only a part of the embodiments of the present disclosure and are not intended to be exhaustive. All other embodiments obtained by those of ordinary skill in the art without making creative work are within the scope of the present disclosure, based on embodiments in the present disclosure.

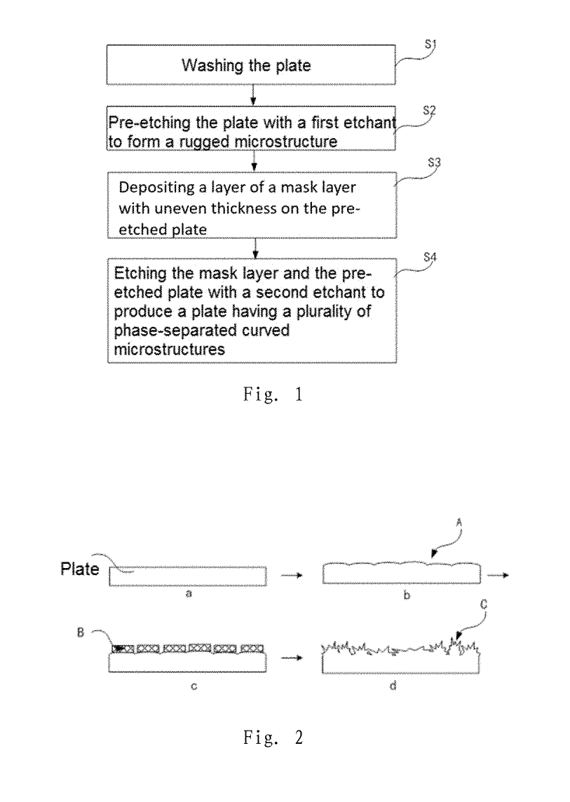

Please refer to FIG. 1 and FIG. 2, FIG. 1 is a schematic flow diagram of an embodiment of the manufacturing method of the anti-glare plate of the present disclosure, FIG. 2 is a schematic structural view of an embodiment of the manufacturing process of the anti-glare plate of the present disclosure, the method includes the following steps:

S1, Washing the plate.

Referring to a) in FIG. 2, the plate may be a transparent material, and may be any substrate such as glass, ceramic substrate or transparent plastic, and the present disclosure is not particularly limited thereto.

S2, Pre-etching the plate with a first etchant to form a rugged microstructure.

The previously washed plate is pre-etched with the first etchant, in the present embodiment, the first etchant may be a mixed acid solution of hydrofluoric acid, phosphoric acid and sulfuric acid at a concentration of 0.5 wt % to 1 wt %, in other embodiments, other concentrations of acid may be used to etch the plate, where the disclosure is not to be further limited. Wherein the purpose of the pre-etching in this step is to etch the plate with a relatively thin etch acid so that the microstructure A is formed on the surface of the plate. The microstructure A of the etching traces is relatively shallow, the shape may be one of an arcuate shape, a tapered shape and a circular pan shape, referring to b) in FIG. 2, which is mainly from the overall anti-glare effect.

S3, Depositing a layer of a mask layer with uneven thickness on the pre-etched plate.

In the case of vapor deposition or sputtering, a mask layer B having a thickness unevenness is deposited on the pre-etched plate. Of course, the deposition method of the mask layer B is not limited to the above two methods, in other embodiments, an electrochemical deposition vapor deposition method or the like may also be used, and is not particularly limited thereto. Wherein the mask layer B material may be a metal, a metal oxide, a silicate, or any material that can react with etchant.

Specifically, at different locations of the plate, the thickness of the mask layer is uniform and the thickness is randomly distributed. Specifically, the mask layer B has a thickness in the range of about 50 nm to about 1 μm, the thickness of the film layer is between 50 nm to 200 nm, the thickness of the film layer is between 500 nm to 1 μm, it can be seen the larger difference between the thinner film thickness and the thicker film thickness, referring to c) in FIG. 2. Of course, the film thickness range in this embodiment is only illustrative, and in other embodiments, it is possible to control the thickness of the film by the vapor deposition or sputtering process, for example, two different mask plates can be used for vapor deposition, so that one of the mask plates has a longer deposition time to ensure that the thickness of the mask layer is thick and the deposition time of the other mask is relatively short, the mask layer thickness is thin, so as to get the thickness of the mask layer.

S4, Etching the mask layer and the pre-etched plate with a second etchant to produce a plate having a plurality of phase-separated curved microstructures.

After the mask layer is deposited again, the second etchant is etched with the mask layer and the pre-etched plate. Wherein the second etchant may be a mixed acid solution of hydrofluoric acid, phosphoric acid and sulfuric acid and the concentration of the second etchant may be from 10 wt % to 20 wt %, in other embodiments, other concentrations of acid may be used to etch the plate, where the disclosure is not to be further limited.

In the present embodiment, since there is a mask layer having a thickness unevenness on the surface of the plate, etching acid solution need to first dissolve the mask layer to etch to the plate surface substrate, the thickness of the mask layer is not uniform, resulting in etching the acid on the plate surface etching time and etching amount is different, and in the mask layer thinner area etching acid etching time is longer, and the etching depth is large, the etching time of the etching solution in the thicker region is shorter and the etching depth is shallow, so that the arc microstructure plate with multiple phase separation is prepared, wherein the phase-separated curved microstructure C can be specifically seen in d) in FIG. 2.

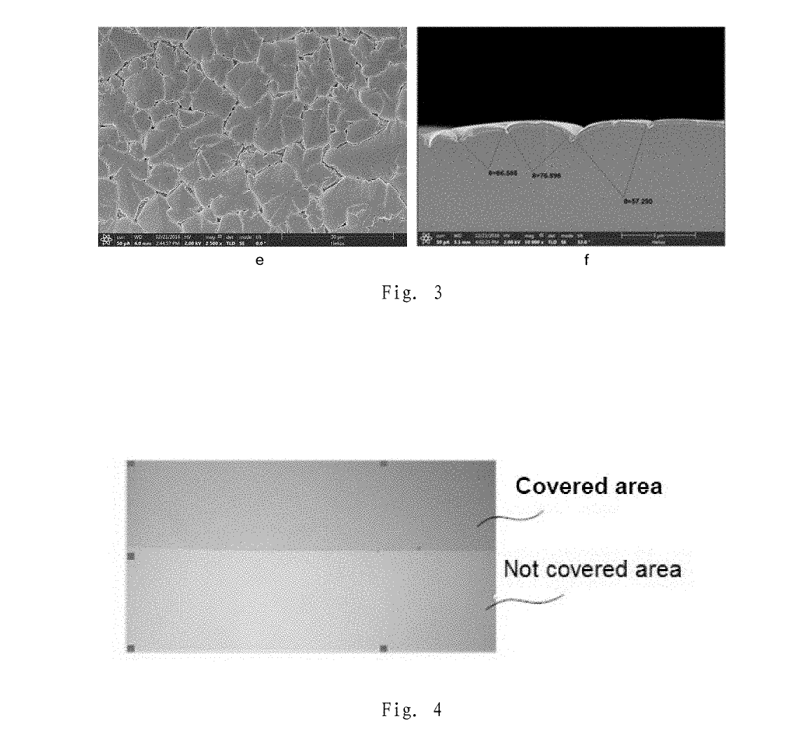

Referring further to FIG. 3, FIG. 3 is a schematic structural view of the anti-glare plate of the present disclosure under specular electron microscopy. As shown in FIG. 3, a groove is formed between the adjacent phase-separated curved microstructures by etching, which is completely different from the conventional spherical concave structure, from the measured data we can see that the arc angle of each curved microstructure is between 50° to 80°, and the surface of each phase is curved, this structure facilitates the formation of optical traps, even if the incoming light cannot escape, weaken the intensity of the reflected light, and diffuse through the surface uneven structure, so as to achieve the anti-glare effect.

Referring to FIG. 4, FIG. 4 is a schematic representation of the display effect of the full HD resolution panel of the present disclosure in a bonded/non-conformable anti-glare plate. As shown in FIG. 4, the area of the anti-glare plate is almost invisible the sparkle phenomenon, indicating that the morphology of the anti-glare microstructure can improve the display panel sparkle phenomenon.

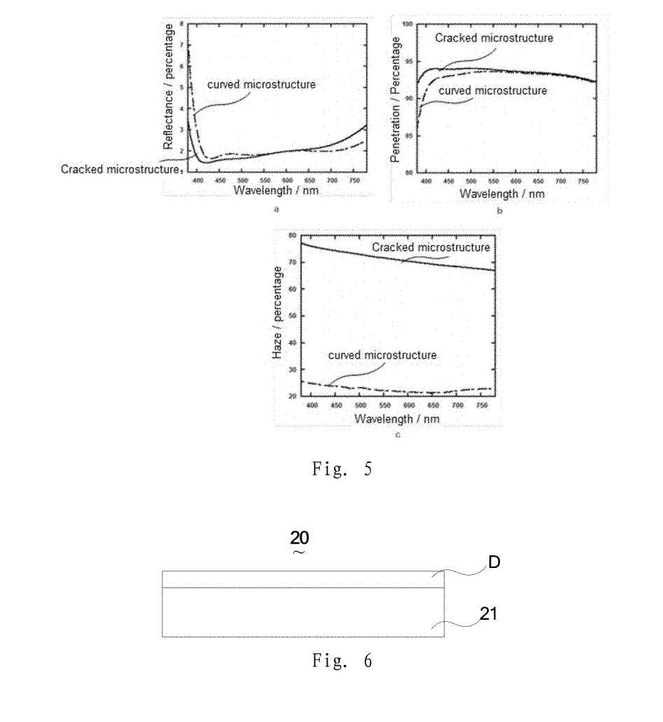

Referring to FIG. 5, FIG. 5 is a schematic view showing the comparison of the optical properties of the surface cracked curved microstructure plate and the surface curved microstructure plate of the present disclosure. Wherein a), b) and c) in FIG. 5 are schematic views showing the reflectance, transmittance and haze value of the curved microstructure plate having a curved surface and the surface layer arc-shaped microstructure plate, respectively. It can be seen from the figure that the reflectivity of the curved microstructure plate on the surface is about 93.61%, the transmittance is about 1.96%, and the haze value is 71.13%, Where haze is the percentage of the transmitted light intensity that deviates from the incident light at an angle of 2.5° to the total transmitted light intensity, the greater the haze, the greater the degree of gloss of the plate, especially the imaging, the more blurred the image, the better the anti-glare effect.

In the above embodiment, a plurality of phase-separated curved microstructures are prepared on the plate by multi-step etching, and the sparkle phenomenon of the plate in the high-resolution panel surface can be improved, and the comfort of the panel reading can be improved.

Referring to FIG. 6, FIG. 6 is a schematic structural view of an embodiment of the display device of the present disclosure. The display device 20 includes an anti-glare plate D made by any of the above methods, and a display panel 21. The anti-glare plate D is adhered to a display surface of the display panel 21, and the manufacturing method and the use instruction of the anti-glare plate D are described in detail in the above-described embodiments, and will not be described here.

In the above embodiment, a plurality of phase-separated curved microstructures are prepared on the plate by multi-step etching, and the sparkle phenomenon of the plate in the high-resolution panel surface can be improved, and the comfort of the panel reading can be improved.

In view of the foregoing, it will be readily understood by those skilled in the art that the present disclosure provides a method of manufacturing an anti-glare plate and a display device, through the multi-step etching on the plate to prepare a number of separated arc microstructure, can improve the plate in the high-resolution panel surface sparkle phenomenon, help to enhance the comfort of panel reading.

The present disclosure is not limited to the embodiments of the present disclosure, but is not intended to limit the scope of the disclosure, and equivalents or equivalents of the present disclosure and the accompanying drawings are used, either directly or indirectly, in other related technical fields, are likewise included within the scope of the patent protection of the present disclosure.

What is claimed is:

1. A method of manufacturing an anti-glare plate, wherein the method comprises:
washing the plate;
pre-etching the plate with a first etchant to form a rugged microstructure;
depositing a layer of a mask layer with uneven thickness on the pre-etched plate;
etching the mask layer and the pre-etched plate with a second etchant to produce a plate having a plurality of phase-separated curved microstructures;
wherein the shape of the microstructure comprises at least one of an arcuate shape, a tapered shape and a circular pan shape;
the mask layer is a metal, a metal oxide and a silicate.

2. The manufacturing method according to claim 1, wherein, the mask layer has a thickness of 50 nm to 1 μm.

3. The manufacturing method according to claim 1, wherein, the surface of each of the phase-separated curved microstructures is cracked.

4. The manufacturing method according to claim 3, wherein, the center angle of each of the phase-separated curved microstructures is 50° to 80°.

5. The manufacturing method according to claim 3, wherein, a groove is formed between the adjacent phase-separated curved microstructures by etching.

6. The manufacturing method according to claim 1, wherein, the first etchant is a mixed acid solution of hydrofluoric acid, phosphoric acid and sulfuric acid, and the concentration of the first etchant is 0.5 wt % to 1 wt %.

7. The manufacturing method according to claim 1, wherein, the second etchant is a mixed acid solution of hydrofluoric acid, phosphoric acid and sulfuric acid, and the concentration of the second etchant is 10 wt % to 20 wt %.

8. A method of manufacturing an anti-glare plate, wherein the method comprises:
washing the plate;
pre-etching the plate with a first etchant to form a rugged microstructure;
depositing a layer of a mask layer with uneven thickness on the pre-etched plate;
etching the mask layer and the pre-etched plate with a second etchant to produce a plate having a plurality of phase-separated curved microstructures.

9. The manufacturing method according to claim 8, wherein, the shape of the microstructure comprises at least one of an arcuate shape, a tapered shape and a circular pan shape.

10. The manufacturing method according to claim 8, wherein, the mask layer is a metal, a metal oxide and a silicate.

11. The manufacturing method according to claim 8, wherein, the mask layer has a thickness of 50 nm to 1 μm.

12. The manufacturing method according to claim 8, wherein, the surface of each of the phase-separated curved microstructures is cracked.

13. The manufacturing method according to claim 12, wherein, the center angle of each of the phase-separated curved microstructures is 50° to 80°.

14. The manufacturing method according to claim 12, wherein, a groove is formed between the adjacent phase-separated curved microstructures by etching.

15. The manufacturing method according to claim 8, wherein, the first etchant is a mixed acid solution of hydrofluoric acid, phosphoric acid and sulfuric acid, and the concentration of the first etchant is 0.5 wt % to 1 wt %.

16. The manufacturing method according to claim 8, wherein, the second etchant is a mixed acid solution of hydrofluoric acid, phosphoric acid and sulfuric acid, and the concentration of the second etchant is 10 wt % to 20 wt %.

17. A display device, wherein the display device comprises an anti-glare plate and a display panel, wherein the anti-glare plate is adhered to a display surface of the display panel;
wherein a method of manufacturing the anti-glare plate comprises:
washing the plate;
pre-etching the plate with a first etchant to form a rugged microstructure;
depositing a layer of the mask with uneven thickness on the plate after the pre-etching;
etching the mask layer and the pre-etched plate with a second etchant to produce a plate having a plurality of phase-separated curved microstructures;
the shape of the microstructure comprising at least one of an arcuate shape, a tapered shape and a circular table shape;
the mask layer is one of metal, metal oxide and silicate;
each of the phase-separated curved microstructures having a crack surface and a central angle of 50° to 80, and a groove being formed between the adjacent phase-separated curved microstructures by etching;
the first etchant is a mixed acid of hydrofluoric acid, phosphoric acid and sulfuric acid, and the concentration of the first etchant is 0.5 wt % to 1 wt %, and the second etchant is a mixed acid of hydrofluoric acid, phosphoric acid and sulfuric acid, and the concentration of the second etchant is from 10 wt % to 20 wt %.
